(19) United States
(12) Patent Application Publication
(10) Pub. No.: US 2019/0047343 A1
(43) Pub. Date: Feb. 14, 2019

(54) BEAM FOR SUSPENSION ASSEMBLIES OF HEAVY-DUTY VEHICLE AXLE/SUSPENSION SYSTEMS

(71) Applicant: Hendrickson USA, L.L.C., Itasca, IL (US)

(72) Inventors: Benedetto A. Naples, Canton, OH (US); Donald R. Hester, East Canton, OH (US)

(21) Appl. No.: 16/100,579

(22) Filed: Aug. 10, 2018

Related U.S. Application Data
(60) Provisional application No. 62/544,942, filed on Aug. 14, 2017.

(51) Int. Cl. B60G 9/00; B60G 11/27

(52) U.S. Cl. CPC B60G 9/003; B60G 11/27; B60G 2300/026; B60G 2204/43; B60G 2202/152; B60G 2200/31

(57) ABSTRACT

A beam for a suspension assembly of a heavy-duty vehicle axle/suspension system that includes reduced wall and/or plate thickness and a recessed area to reduce the overall weight of the beam. The structure of the beam enables an air spring to be mounted directly on the beam without additional air spring mounting components.

### CROSS-REFERENCE TO RELATED APPLICATION

This application claims the benefit of U.S. Provisional Patent Application Ser. No. 62/544,942 filed Aug. 14, 2017.

### BACKGROUND

### Technical Field

The subject matter of this application relates generally to suspension assemblies for axle/suspension systems of heavy-duty vehicles, such as trucks and tractor-trailers. More particularly, the subject matter of this application relates to beams for suspension assemblies of heavy-duty vehicle axle/suspension systems. More specifically, the subject matter of this application is directed to a beam for a suspension assembly of a heavy-duty vehicle axle/suspension system that has an optimized structure with reduced wall and/or plate thickness and a recessed area, which reduces the weight of the beam, and thus the overall weight of the suspension assembly and axle/suspension system, while maintaining functionality and durability of the beam. In addition, the beam includes a structure that enables an air spring to be mounted directly on the beam, which eliminates the need for additional air spring mounting components, thereby further reducing the overall weight of the suspension assemblies, and thus the axle/suspension system, and reduces manufacturing complexity and costs by requiring fewer components.

### Background Art

The use of air-ride trailing and leading arm rigid beam-type axle/suspension systems has been very popular in the heavy-duty truck and tractor-trailer industry for many years. Although such axle/suspension systems can be found in widely varying structural forms, in general their structure is similar in that each system typically includes a pair of suspension assemblies. In some heavy-duty vehicles, the suspension assemblies are connected directly to the primary frame of the vehicle. In other heavy-duty vehicles, the primary frame of the vehicle supports a subframe, and the suspension assemblies connect directly to the subframe. For those heavy-duty vehicles that support a subframe, the subframe can be non-movable or movable, the latter being commonly referred to as a slider box, slider subframe, slider undercarriage, secondary slider frame, or bogie. For the purpose of conciseness and clarity, reference herein will be made to main members, with the understanding that such reference is by way of example, and that the disclosed subject matter applies to heavy-duty vehicle axle/suspension systems suspended from main members of: primary frames, movable subframes and non-movable subframes, and the like.

Each suspension assembly of an axle/suspension system generally includes a longitudinally extending elongated beam. Each beam typically is located adjacent to and below a respective one of a pair of spaced-apart longitudinally extending main members and one or more cross members, which form the frame of the slider or vehicle. More specifically, each beam is pivotally connected at one of its ends to a hanger, which in turn is attached to and depends from a respective one of the main members of the vehicle. An axle extends transversely between and typically is connected to or captured by the beams of the pair of suspension assemblies at a selected location from about the mid-point of each beam to the end of the beam opposite from its pivotal connection to the hanger. The beam opposite its pivotal connection to the hanger is typically connected to a force reacting suspension component, such as an air spring, or its equivalent, which in turn is connected to a respective one of the main members. A height control valve is mounted on the main member or other support structure and is operatively connected to the beam and to the air spring in order to maintain the ride height of the vehicle. A brake system and/or one or more shock absorbers for providing damping to the axle/suspension system of the vehicle may also be mounted on the axle/suspension system. The beam may extend rearwardly or frontwardly from the pivotal connection relative to the front of the vehicle, thus defining what are typically referred to as trailing arm or leading arm axle/suspension systems, respectively. However, for purposes of the description contained herein, it is to be understood that the term “trailing arm” will encompass beams that extend either rearwardly or frontwardly with respect to the front end of the vehicle.

The axle/suspension systems of the heavy-duty vehicle act to cushion the ride, dampen vibrations, and stabilize the vehicle. More particularly, as the vehicle is traveling over the road, its wheels encounter road conditions that impart various forces, loads, and/or stresses, collectively referred to herein as forces, to the respective axle on which the wheels are mounted, and in turn, to the suspension assemblies that are connected to and support the axle. In order to minimize the detrimental effect of these forces on the vehicle as it is operating, the axle/suspension system is designed to react at least some of them.

These forces include vertical forces caused by vertical movement of the wheels as they encounter certain road conditions, fore-aft forces caused by acceleration and deceleration of the vehicle, and lateral and torsional forces associated with transverse vehicle movement, such as turning of the vehicle and lane-change maneuvers. In order to address such disparate forces, axle/suspension systems have differing structural requirements. More particularly, it is desirable for an axle/suspension system to be fairly stiff in order to minimize the amount of sway experienced by the vehicle and thus provide what is known in the art as roll stability. However, it is also desirable for an axle/suspension system to be relatively flexible to assist in cushioning the vehicle from vertical impacts, and to provide compliance so that the components of the axle/suspension system resist failure, thereby increasing durability of the axle/suspension system.

Prior art beams of suspension assemblies for heavy-duty vehicles typically have relatively thick walls to provide the necessary rigidness and/or stiffness to withstand forces imparted on the beam during operation of the vehicle, which increases the overall weight of the suspension assemblies, and thus the heavy-duty vehicle. In addition, prior art beams of suspension assemblies for heavy-duty vehicles typically include supplementary air spring mounting components, such as cast or fabricated pedestals and the like, for mounting the air spring to the beam, which increases manufacturing complexity and further increases the overall weight of the suspension assemblies, and thus the heavy-duty vehicle. Because most jurisdictions have maximum weight limits for heavy-duty vehicles, having heavier beams, and thus suspension assemblies typically results in less carrying capacity for the vehicle.

Thus, there is a need in the art for a beam for suspension assemblies of heavy-duty vehicles with reduced weight, that maintains functionality and durability of the beam, and that reduces the overall vehicle weight and increases the amount of cargo that can be carried by the vehicle. There is also a need in the art for a beam that eliminates the need for supplementary air spring mounting components to mount an air spring to the beam, to further reduce the overall vehicle weight and reduce manufacturing complexity of the axle/suspension system by requiring fewer components to mount the air springs to the beams. The beam for suspension assemblies of heavy-duty vehicle axle/suspension systems of the disclosed subject matter satisfies these needs, as will be described below.

### BRIEF SUMMARY OF THE DISCLOSED SUBJECT MATTER

An objective of the disclosed subject matter is to provide a beam for suspension assemblies of heavy-duty vehicle axle/suspension systems that is optimized in order to reduce the wall thickness of the beam.

Another objective of the disclosed subject matter is to provide a beam for suspension assemblies of heavy-duty vehicle axle/suspension systems that enables an air spring of the axle/suspension system to be mounted directly to the beam.

Yet another objective of the disclosed subject matter is to provide a beam for suspension assemblies of heavy-duty vehicle axle/suspension systems that eliminates additional supplementary air spring mounting components.

Another objective of the disclosed subject matter is to provide a beam for suspension assemblies of heavy-duty vehicle axle/suspension systems with reduced weight, that maintains functionality and durability.

Yet another objective of the disclosed subject matter is to provide a beam for suspension assemblies of heavy-duty vehicle axle/suspension systems that reduces manufacturing complexity and costs.

These objectives and others are achieved by the beam for suspension assemblies of heavy-duty vehicle axle/suspension systems of the disclosed subject matter which includes a first end, the beam being pivotally connected to a frame of the heavy-duty vehicle adjacent the first end; a second end, an air spring being mounted on the beam adjacent the second end without intervening structure between the air spring and the beam, the air spring being connected to the heavy-duty vehicle frame; a recessed area formed in the beam; and an axle rigidly attached to the beam.

### BRIEF DESCRIPTION OF THE SEVERAL VIEWS OF THE DRAWINGS

The following description and drawings set forth certain illustrative aspects and implementations of the disclosed subject matter. These are indicative of but a few of the various ways in which one or more aspects or implementations or concepts of the disclosed subject matter may be employed. Further features and advantages of the disclosed subject matter will become apparent to those skilled in the art from reading the following description with reference to the accompanying drawings, in which:

FIG. 1 is a fragmentary elevational view of a portion of a heavy-duty vehicle axle/suspension system, looking in an inboard direction, showing a passenger-side suspension assembly of the axle/suspension system incorporating a prior art beam, showing an axle in cross-section disposed through and attached to the beam, and showing an air spring mounted to the beam with a pedestal;

FIG. 2 is an enlarged elevational view of selected components of the axle/suspension system shown in FIG. 1, looking in an inboard direction, including the prior art beam and the axle (shown in section);

FIG. 3 is a top rear perspective view, looking in an outboard direction, of a driver-side suspension assembly of a trailing arm air-ride axle/suspension system that incorporates an exemplary embodiment beam of the disclosed subject matter, showing an axle in cross-section disposed through and attached to the beam, and showing a piston of an air spring mounted directly to the beam;

FIG. 4 is top rear perspective view, looking in an inboard direction, of the beam and air spring piston of the suspension assembly incorporating the exemplary embodiment beam of the disclosed subject matter shown in FIG. 3, with the axle and disc brake assembly removed;

FIG. 5 is a bottom plan view of the driver-side exemplary embodiment beam of the disclosed subject matter shown in FIG. 4;

FIG. 6 is a bottom rear perspective view, looking in an inboard direction, of the driver-side exemplary embodiment beam of the disclosed subject matter shown in FIG. 4;

FIG. 7 is a top rear perspective view, looking in an inboard direction, of the exemplary embodiment beam of the disclosed subject matter shown in FIG. 3; and

FIG. 8 is an elevational view, looking in an inboard direction, of the exemplary embodiment beam of the disclosed subject matter shown in FIG. 3, showing the orientation of the beam top plate relative to a line extending between the beam pivot point and the axle centerline and relative to the beam sidewall openings.

Similar numbers and characters refer to similar parts throughout the drawings.

### DETAILED DESCRIPTION OF THE DISCLOSED SUBJECT MATTER

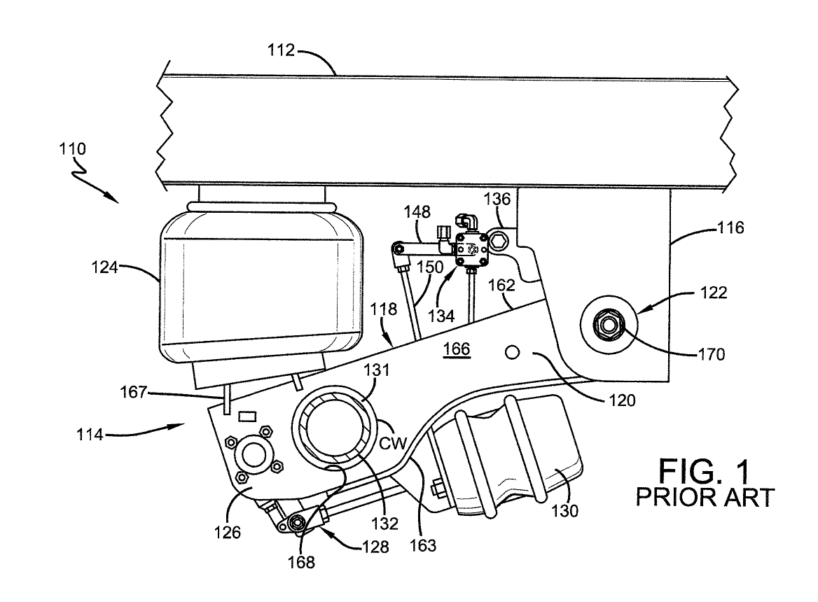

In order to better understand the exemplary embodiment beam for suspension assemblies of heavy-duty vehicles of the disclosed subject matter, and the environment in which it operates, a trailing arm beam-type air-ride axle/suspension system for heavy-duty vehicles that incorporates a pair of prior art beams is shown in FIG. 1, and is indicated generally at 110. Reference shall be made generally to heavy-duty vehicles for purposes of conciseness and clarity, with the understanding that such reference includes trucks, trailers, tractor-trailers, semi-trailers, and the like.

Axle/suspension system 110 is typically mounted on a pair of longitudinally-extending spaced-apart main members 112 (only one shown) of a heavy-duty vehicle, which is generally representative of various types of frames used for heavy-duty vehicles, including primary frames that do not support a subframe and primary frames and/or floor structures that do support a subframe. For primary frames and/or floor structures that do support a subframe, the subframe can be non-movable or movable, the latter being commonly referred to as a slider box.

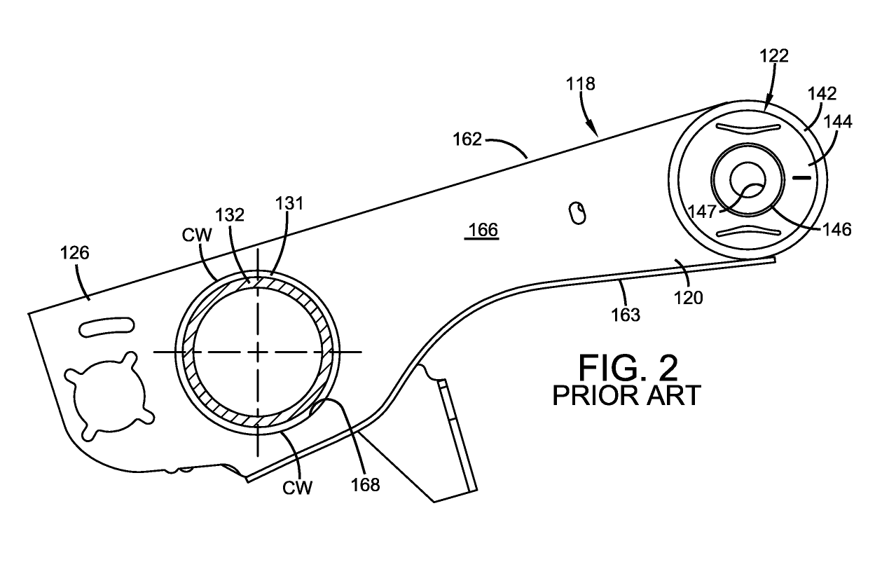

With particular reference to FIG. 1, axle/suspension system 110 includes a pair of suspension assemblies 114 (only one shown). Because axle/suspension system 110 generally includes an identical pair of suspension assemblies 114, for purposes of conciseness and clarity, only one of the suspension assemblies will be described below. Each suspension assembly 114 includes a prior art trailing arm pass-through overslung beam 118, which is pivotally connected to a respective one of a pair of transversely spaced hangers 116 (only one shown) that are mounted to and depend from its respective main member 112 of the frame or subframe of the heavy-duty vehicle. More specifically, and with additional reference to FIG. 2, prior art beam 118 includes a front end 120 with a bushing assembly 122, which is utilized to pivotally connect the beam to a respective one of hangers 116. Prior art beam 118 also includes a rear end 126. A pair of transversely aligned openings 168 are formed in a pair of sidewalls 166 of prior art beam 118 near rear end 126 of the beam. An axle 132 is disposed through openings 168 of sidewalls 166 of each prior art beam 118 and extends transversely between the beams. An axle wrap 131 is disposed about axle 132 between the axle and openings 168 of each respective prior art beam 118 and is rigidly attached to the axle via welds or other suitable means. More specifically, axle wrap 131 in turn is rigidly attached to each one of pair of sidewalls 166 of a respective prior art beam 118 via circumferential welds CW (only one shown in FIG. 2) laid between the axle wrap and the sidewalls.

With particular reference to FIG. 1, suspension assembly 114 also includes an air spring 124 mounted on an air spring mounting pedestal 167, which is attached to a top wall 162 of prior art beam 118 near beam rear end 126. Air spring 124 extends between prior art beam 118 and main member 112 and is rigidly attached to the main member by suitable means, such as welds or fasteners. A height control valve 134 is mounted on hanger 116 via a bracket 136 in a manner well in the art. Height control valve 134 includes a lever 148 that is attached to prior art beam 118 via a link 150 and a bracket (not shown). For the sake of relative completeness, a brake chamber 130 of a drum brake assembly 128 is shown mounted on suspension assembly 114.

As mentioned above, axle/suspension system 110 is designed to react forces that act on the heavy-duty vehicle during operation. More particularly, it is desirable for axle/suspension system 110 to be rigid or stiff in order to resist roll forces and thus provide roll stability for the vehicle. This is typically accomplished by using prior art beam 118. It is also desirable, however, for axle/suspension system 110 to be flexible to assist in cushioning the vehicle (not shown) from vertical impacts and to provide compliance so that the axle/suspension system resists failure. Such flexibility typically is achieved through the pivotal connection of prior art beam 118 to hanger 116 with bushing assembly 122. Air spring 124 and a shock absorber (not shown) also assist in cushioning and controlling, respectively, the ride for cargo and passengers.

With continued reference to FIGS. 1-2, prior art beam 118 typically is formed of a rigid material, such as steel, and includes sidewalls 166 integrally formed with top wall 162 in a generally inverted U-shape. A bottom plate 163 is attached to the bottom ends of sidewalls 166 via welds. Bottom plate 163, sidewalls 166 and top wall 162 have a material thickness of about 0.22 inches. Prior art beam 118 also includes a mounting tube 142 formed of robust steel rigidly attached to the front ends of sidewalls 166, top wall 162, and bottom plate 163. Bushing assembly 122 is of a type that is well known in the art and includes an elastomeric bushing 144, which is press fit into mounting tube 142 of prior art beam 118. Bushing 144 is molded about and adhesively attached to a central sleeve 146 formed with a continuous opening 147. Central sleeve 146 passes completely through bushing 144 and extends outwardly from the sidewalls thereof, and facilitates pivotal mounting of prior art beam 118 to hanger 116 via a fastener assembly 170.

Top wall 162, bottom plate 163, and sidewalls 166 of prior art beam 118 have relatively thick walls to provide necessary strength/rigidness to sufficiently react forces imparted on the beam during operation of the vehicle, which increases the overall weight of suspension assembly 114, and thus the overall weight of axle/suspension system 110 and the heavy-duty vehicle. In addition, prior art beam 118 requires air spring mounting pedestal 167, or other supplemental air spring mounting components, for mounting air spring 124 to the beam, which further increases the weight of suspension assembly 114, and thus axle/suspension system 110 and the heavy-duty vehicle, and also increases manufacturing complexity and costs. Although prior art beam 118 satisfactorily performs its intended function, because most jurisdictions have maximum weight limits for heavy-duty vehicles, the use of heavier beams typically results in less carrying capacity for the vehicle. Therefore, it is typically desirable to reduce the weight of the beam, while maintaining functionality and durability of the beam, in order to increase the amount of cargo that can be carried by the vehicle. Moreover, it is desirable to have a beam that reduces manufacturing complexity and costs by requiring fewer components to mount an air spring to a beam. The beam of the disclosed subject matter overcomes the disadvantages associated with prior art beams and will now be described.

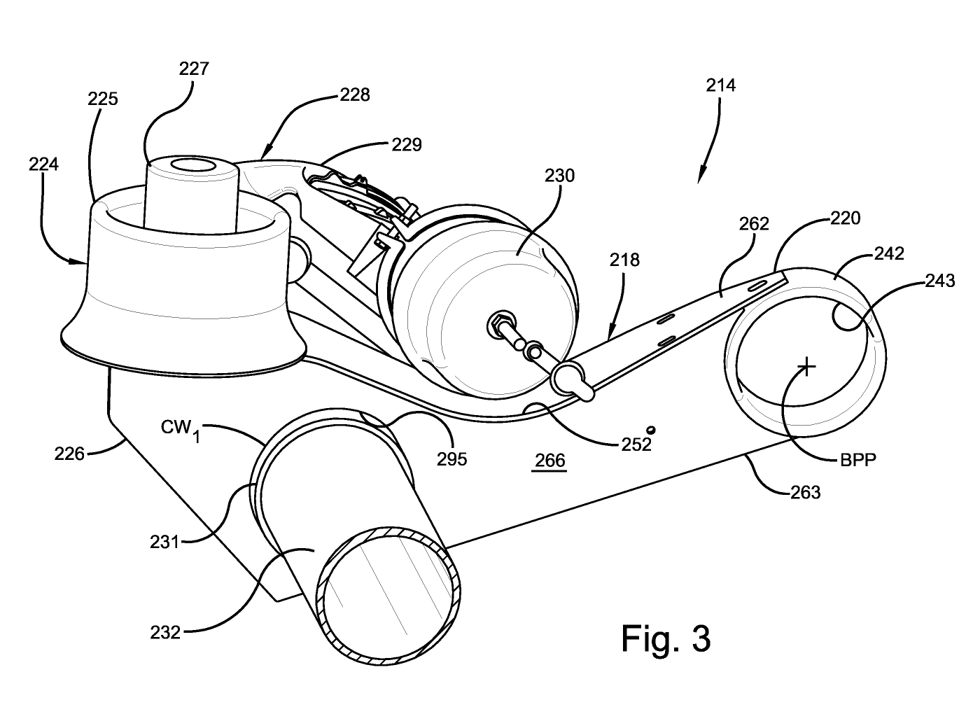

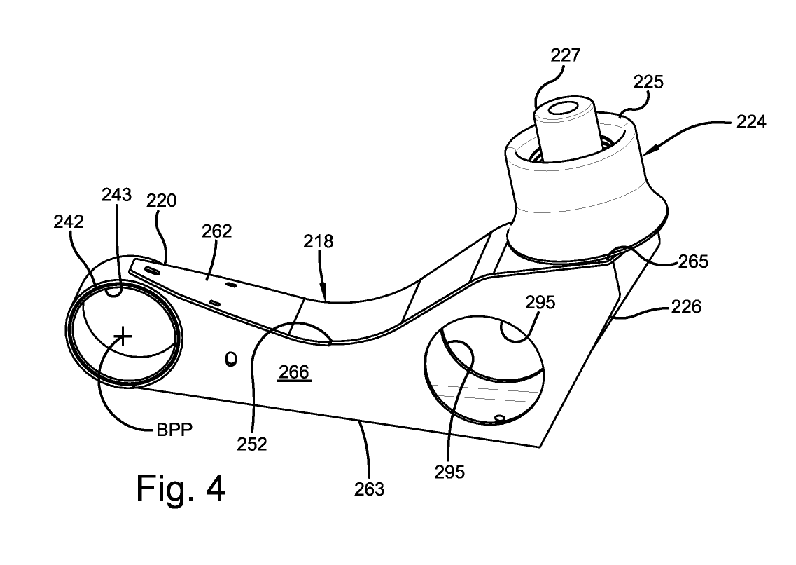

An exemplary embodiment beam for suspension assemblies of heavy-duty vehicles of the disclosed subject matter is shown in FIGS. 3-8, and is indicated generally at 218. Exemplary embodiment beam 218 is shown utilized with one of a pair of identical suspension assemblies 214 of a heavy-duty vehicle axle/suspension system (not shown) similar in structure to axle/suspension system 110 (FIGS. 1-2) described above. For purposes of conciseness and clarity, only one suspension assembly 214 incorporating exemplary embodiment beam 218 will be described below.

Suspension assembly 214 includes exemplary embodiment beam 218, the structure of which will be described in greater detail below. Exemplary embodiment beam 218 is pivotally connected to a respective one of a pair of transversely spaced hangers (not shown) that are mounted to and depend from a respective main member of a frame or subframe (not shown) of the heavy-duty vehicle. More specifically, exemplary embodiment beam 218 includes a front end 220 having a bushing assembly (not shown) similar to bushing assembly 122 described above (FIGS. 1-2), which is utilized to pivotally connect the beam to a respective one of the hangers. Exemplary embodiment beam 218 may extend rearwardly or frontwardly from the pivotal connection relative to the front of the vehicle, thus defining what are typically referred to as trailing arm or leading arm axle/suspension systems, respectively. However, for purposes of the description contained herein, it is understood that the term “trailing arm” will encompass beams that extend either rearwardly or frontwardly with respect to the front end of the vehicle. With particular reference to FIGS. 3-4 and 8, the pivotal attachment of exemplary embodiment beam 218 to the hanger creates a beam pivot point BPP about which the beam may pivot. Exemplary embodiment beam 218 also includes a rear end 226, which is welded or otherwise rigidly attached to a transversely extending axle 232 (FIG. 3), as will be described in greater detail below.

With reference to FIGS. 3-6, suspension assembly 214 includes an air spring 224 (only a piston 225 and a bumper 227 of the air spring is shown), or other suitable force reacting suspension component, mounted on rear end 226 of exemplary embodiment beam 218, as will be described in greater detail below. Air spring 224 extends between and is connected to a respective one of the heavy-duty vehicle frame or subframe main members (not shown). Suspension assembly 214 can also include a shock absorber (not shown) mounted to exemplary embodiment beam 218 and extending between and being attached to the hanger or frame or subframe main members. For the sake of relative completeness, a brake chamber 230 and caliper 229 of a disc brake assembly 228 is shown mounted on axle 232.

Exemplary embodiment beam 218 includes a top plate 262, a pair of outboard and inboard sidewalls 266, and a bottom wall 263. Top plate 262, sidewalls 266, and bottom wall 263 may be formed out of any suitable rigid material, such as a metal. For example, top plate 262, sidewalls 266, and bottom wall 263 may be cut from flat sheets of steel and then welded together. Alternatively, two or more of top plate 262, sidewalls 266, and bottom wall 263 may be formed as a single piece of steel and then bent to form two or more wall surfaces. For example, sidewalls 266 and bottom wall 263 may be formed from a single sheet of metal, whereby the sidewalls are bent 90 degrees from the bottom plate into a generally U-shaped structure to form the three walls. In some configurations, top plate 262 and bottom wall 263 may overlap sidewalls 266. Those of ordinary skill in the art will appreciate that top plate 262, sidewalls 266, and bottom wall 263 may be formed from other materials, shaped in other ways, connected together in other ways, and/or even be formed from a single piece of material, such as a composite, and printed with a 3-D printer, for example. Top plate 262 is curved downwardly-rearwardly and then upwardly-rearwardly, moving in the direction from beam front end 220 toward beam rear end 226, to create a recessed area 252 for accommodating brake chamber 230, while maintaining the desired spacing between disc brake assembly 228 and exemplary embodiment beam 218.

Exemplary embodiment beam 218 includes a mounting tube 242, which is rigidly attached to the front ends of top plate 262, sidewalls 266, and bottom wall 263. Mounting tube 242 may be formed by cutting it from a section of circular metal having a suitable diameter. Mounting tube 242 includes an opening 243. An elastomeric bushing (not shown) of the bushing assembly is press-fit into opening 243 and facilitates pivotal connection of exemplary embodiment beam 218 to the respective hanger via a fastener assembly (not shown).

Sidewalls 266 of exemplary embodiment beam 218 are each formed with a respective one of a pair of transversely aligned beam openings 295. With reference to FIG. 3, axle 232 is disposed through beam openings 295. A pair of axle wraps 231 are welded or otherwise rigidly attached to axle 232 and are transversely spaced from one another on the axle such that each one of the pair of wraps is disposed between beam openings 295 of a respective exemplary embodiment beam 218. Each axle wrap 231 in turn is welded or otherwise rigidly attached to its respective exemplary embodiment beam 218 at beam openings 295 via circumferential welds CW₁ (only one shown) to rigidly attach each beam to axle 232 with the axle being substantially surrounded by sidewalls 266 of each beam.

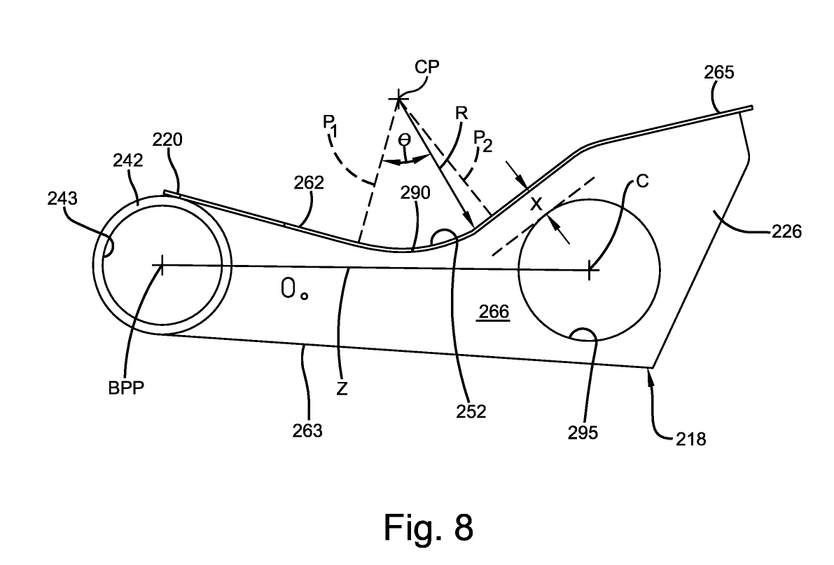

In accordance with an important aspect of the disclosed subject matter, exemplary embodiment beam 218 has an optimized structure that reduces the weight of the beam compared to prior art beams, such as beam 118 described above (FIGS. 1-2), while maintaining functionality and durability of the beam. More specifically, top plate 262 includes a central portion that has a generally concave downward curvature when viewed from the driver side or passenger side of the vehicle. Sidewalls 266 have curved/concave top edges 290 (FIG. 8) similar/complementary to top plate 262 such that the top plate is snugly positioned on the sidewalls. Together, the generally concave downward curvature of top plate 262 and corresponding curved/concave top edges 290 of sidewalls 266 form recessed area 252 on the top surface of exemplary embodiment beam 218. Because exemplary embodiment beam 218 includes recessed area 252, the beam requires less material to manufacture, which reduces the weight of the beam as compared to prior art beams. In addition, recessed area 252 enables brake chamber 230 to be positioned above at least a portion of the beam 218 adjacent to the recessed area.. It is to be understood that the generally concave downward curvature of top plate 262 and curved/concave top edges 290 of sidewalls 266 may be any suitable shape to create a desired recessed area 252, which reduces the amount of material required to form the beam.

With reference to FIG. 8, recessed area 252 is preferably positioned above a line Z drawn through beam pivot point BPP and a center C of axle 232. More preferably, recessed area 252 is positioned at least about 0.50″ above line Z drawn through beam pivot point BPP and center C of axle 232. Most preferably, recessed area 252 is positioned at least about 0.70″ above line Z drawn through beam pivot point BPP and center C of axle 232. However, depending on desired configuration(s) of the axle/suspension system and/or overall suspension assembly configuration(s), other desired locations of recessed area 252 may be employed. In some configurations, such as that shown, some portion(s) of curved/concave top edges 290 of sidewalls 266 may trace a generally circular curve. For example, the portion of curved/concave top edges 290 between points P1 and P2 shown in FIG. 8 may be generally circular in shape between the two points with a radius of R and a center point of CP. Thus, the curved portion forms an angle theta θ between P1 and P2. It is to be understood that curved/concave top edges 290 do not need to include continuous curves, but may be partially shaped having a segment of a circle without affecting the overall concept or operation of the disclosed subject matter. Alternatively, each curved/concave top edge 290 may be formed with two or more straight-line edges without having any curved portions to form recessed area 252 without affecting the overall concept or operation of the disclosed subject matter.

Furthermore, the structure of exemplary embodiment beam 218 enables bottom wall 263, sidewalls 266 and top plate 262 to be relatively thinner compared to prior art beams, such as prior art beam 118 described above (FIGS. 1-2), which further reduces the weight of the beam, while maintaining sufficient functionality and durability to withstand forces imparted on the beam during operation of the heavy-duty vehicle. Bottom wall 263, sidewalls 266 and/or top plate 262 preferably have a material thickness of less than about 0.22 inches. Bottom wall 263, sidewalls 266 and/or top plate 262 most preferably have a material thickness of about 0.179 inches.

In addition, exemplary embodiment beam 218 includes a structure and geometry in which sidewalls 266 substantially surround axle 232, while satisfying minimum beam sidewall section requirements for manufacturability and durability of the beam when placed in service. For example, suspension assembly 214 includes a structure in which axle wrap 231 is a distance X of at least about 1 inch from top plate 262 of exemplary embodiment beam 218, which reduces strain on circumferential weld CW. Additionally, the position of air spring 224 relative to beam pivot point BPP of exemplary embodiment beam 218 and axle 232 provides enhanced dynamic performance to suspension assembly 214, and thus the axle/suspension system, by providing a more desirable lever arm ratio and enabling the pressure of air spring 224 to be decreased. For example, suspension assembly 214 incorporating exemplary embodiment beam 218 of the disclosed subject matter includes a lever arm ratio of at least about 1.34, whereas suspension assemblies with prior art beams typically include relatively lower lever arm ratios, such as suspension assembly 114 with prior art beam 118 (FIGS. 1-2), which includes a lever arm ratio of 1.26. Furthermore, maintaining a height of sidewalls 266 above line Z drawn through beam pivot point BPP and center C of axle 232 provides desirable reaction to in-service forces.

As mentioned above, the axle/suspension system with suspension assemblies 214 incorporating exemplary embodiment beams 218 is designed to react forces that act on the vehicle as it is operating. These forces include vertical forces caused by vertical movement of the wheels as they encounter certain road conditions, fore-aft forces caused by acceleration and deceleration of the vehicle, and lateral and torsional forces associated with transverse vehicle movement, such as turning of the vehicle and lane-change maneuvers. Exemplary embodiment beam 218 of the disclosed subject matter having a reduced material thickness sufficiently reacts all of these forces imparted on suspension assembly 214. In addition, an axle/suspension system needs to be fairly stiff in order to minimize the amount of sway experienced by the vehicle and thus provide what is known in the art as roll stability. More particularly, it is desirable for the axle/suspension system to be rigid or stiff in order to resist roll forces, and thus provide roll stability for the vehicle. Exemplary embodiment beam 218 of the disclosed subject matter having a reduced material thickness is sufficiently rigid or stiff to resist roll forces imparted on suspension assembly 214, and thus provides sufficient roll stability to the axle/suspension system and the heavy-duty vehicle. Exemplary embodiment beam 218, while having reduced material thickness, maintains functionality and durability for use in suspension assemblies of axle/suspension systems with a weight rating of up to about 20,000 lbs/axle.

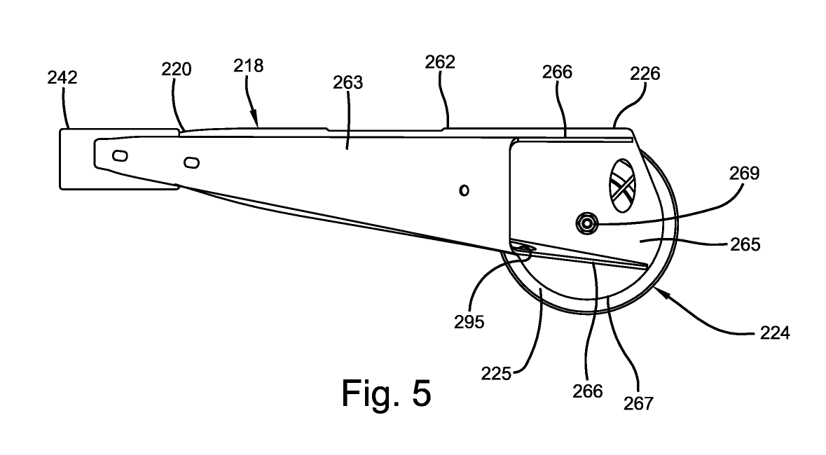

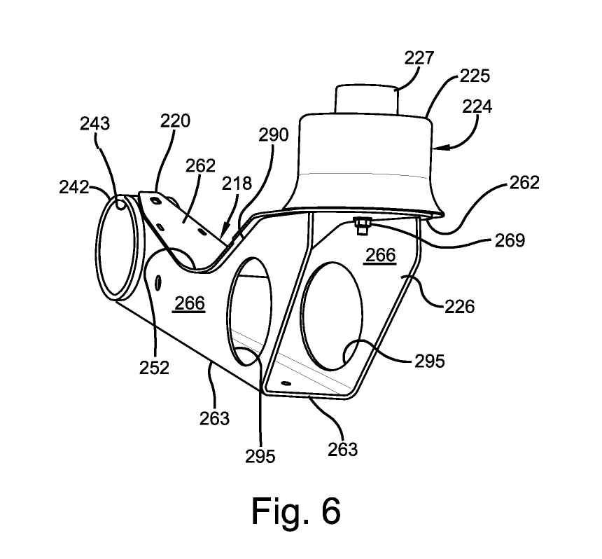

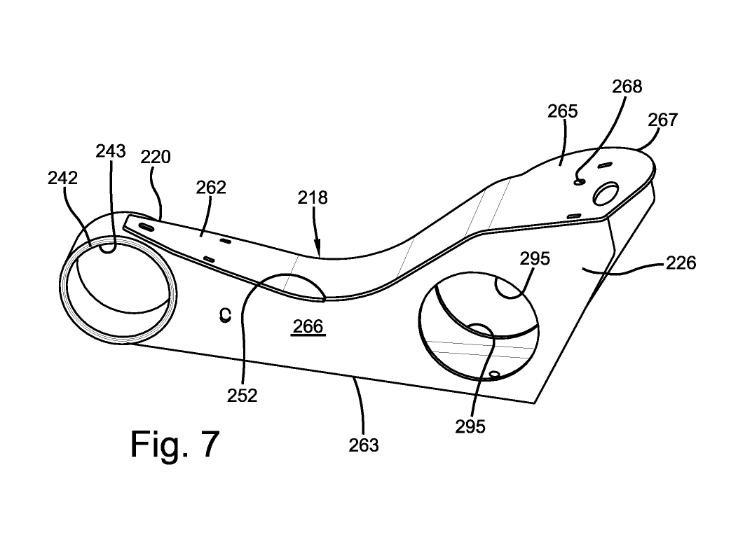

In accordance with another important aspect of the disclosed subject matter, top plate 262 of exemplary embodiment beam 218 includes an integrally formed air spring mounting platform 265 at rear end 226. Air spring mounting platform 265 includes a generally curved perimeter edge 267 that extends inboardly and rearwardly from exemplary embodiment beam 218 (FIG. 7). Air spring mounting platform 265 is formed with a circular opening 268 through which a fastener 269 is disposed and is utilized to attach piston 225, and thus air spring 224, directly to the air spring mounting platform (FIGS. 5-6). An elliptical opening 270 is formed in air spring mounting platform 265. Because exemplary embodiment beam 218 enables air spring 224 to be mounted directly to the beam without intervening structure, the beam eliminates the need for supplemental air spring mounting components, such as pedestals and the like, that are typically required to mount the air springs on prior art beams, which reduces the overall weight of the beam and/or suspension assembly 214 and reduces the manufacturing complexity and costs of the axle/suspension system by requiring less components. In addition, by mounting air spring 224 directly on beam 218, forces imparted on suspension assembly 214 during operation of the vehicle are better distributed.

Thus, exemplary embodiment beam 218 for suspension assemblies of heavy-duty vehicle axle/suspension systems of the disclosed subject matter overcomes the problems of the prior art by providing a beam with reduced wall and/or plate thickness and a recessed area, which reduces the weight of the beam, and thus the overall weight of the suspension assemblies and axle/suspension system, while maintaining functionality and durability of the beam. In addition, exemplary embodiment beam 218 includes a structure that enables an air spring to be mounted directly on the beam, which eliminates the need for additional air spring mounting components, thereby further reducing the weight of the suspension assemblies, and thus axle/suspension system, and reduces manufacturing complexity and costs by requiring fewer components.

It is contemplated that exemplary embodiment beam 218 of the disclosed subject matter could be utilized on trucks, tractor-trailers or other heavy-duty vehicles having one or more axles without changing the overall concept or operation of the disclosed subject matter. It is further contemplated that exemplary embodiment beam 218 of the disclosed subject matter could be utilized on vehicles having frames or subframes which are moveable or non-moveable without changing the overall concept or operation of the present invention. It is even further contemplated that exemplary embodiment beam 218 of the disclosed subject matter could be utilized on all types of air-ride leading and/or trailing arm beam-type axle/suspension system designs known to those skilled in the art without changing the overall concept or operation of the present invention. For example, the disclosed subject matter finds application in beams or arms that are made of materials other than steel, such as aluminum, other materials, metal alloys, composites, and the like, including combinations thereof. It is also contemplated that exemplary embodiment beam 218 of the disclosed subject matter could be utilized on axle/suspension systems having suspension assemblies with generally U-shaped or inverted U-shaped configurations without changing the overall concept or operation of the present invention. It is also contemplated that exemplary embodiment beam 218 of the disclosed subject matter could be utilized with other types of axle wraps or sleeves, such as those including depressions or window welds, without changing the overall concept or operation of the present invention.

Accordingly, the beam for suspension assemblies of heavy-duty vehicles of the subject disclosure is simplified, provides an effective, safe, inexpensive, and efficient structure which achieves all the enumerated objectives, provides for eliminating difficulties encountered with prior art axle/suspension systems, and solves problems and obtains new results in the art.

In the foregoing description, certain terms have been used for brevity, clarity and understanding; but no unnecessary limitations are to be implied therefrom beyond the requirements of the prior art, because such terms are used for descriptive purposes and are intended to be broadly construed. Moreover, the disclosed subject matter has been described with reference to a specific embodiment. It shall be understood that this illustration is by way of example and not by way of limitation, as the scope of the invention is not limited to the exact details shown or described. Potential modifications and alterations will occur to others upon a reading and understanding of the subject disclosure, and it is understood that the disclosed subject matter includes all such modifications, alterations, and equivalents thereof.

Having now described the features, discoveries and principles of the disclosed subject matter, the manner in which the beam of the disclosed subject matter is constructed, arranged and used, the characteristics of the construction and arrangement, and the advantageous, new and useful results obtained; the new and useful structures, devices, elements, arrangements, parts and combinations are set forth in the appended claims.

What is claimed is:

1. A beam for a suspension assembly of a heavy-duty vehicle axle/suspension system, said beam comprising:
a first end, said beam being pivotally connected to a frame of said heavy-duty vehicle adjacent said first end;
a second end, an air spring being mounted on the beam adjacent said second end without intervening structure between said air spring and said beam, the air spring being connected to said heavy-duty vehicle frame;
a recessed area formed in a top surface of the beam; and
an axle rigidly attached to said beam.

2. The beam for a suspension assembly of a heavy-duty vehicle axle/suspension system of claim 1, said beam further comprising a top wall, a bottom wall, an inboard sidewall, and an outboard sidewall connected with each other to form said beam, at least one of said top wall, said bottom wall, said inboard sidewall, and said outboard sidewall having a material thickness of less than 0.22 inches.

3. The beam for a suspension assembly of a heavy-duty vehicle axle/suspension system of claim 1, said beam further comprising a top wall, a bottom wall, an inboard sidewall, and an outboard sidewall connected with each other to form said beam, at least one of said top wall, said bottom wall, said inboard sidewall, and said outboard sidewall having a material thickness of about 0.179 inches.

4. The beam for a suspension assembly of a heavy-duty vehicle axle/suspension system of claim 1, wherein said recessed area is formed by a geometry of the connection of a top wall of said beam to an inboard sidewall and an outboard sidewall of the beam.

5. The beam for a suspension assembly of a heavy-duty vehicle axle/suspension system of claim 4, wherein said recessed area has a generally curved shaped.

6. The beam for a suspension assembly of a heavy-duty vehicle axle/suspension system of claim 4, wherein said inboard sidewall and said outboard sidewall are formed with transversely aligned openings, said axle being disposed through said openings and being substantially surrounded by said beam.

7. The beam for a suspension assembly of a heavy-duty vehicle axle/suspension system of claim 6, further comprising an axle wrap disposed around said axle, said wrap being disposed through said transversely aligned openings and rigidly attaching the axle to said beam.

8. The beam for a suspension assembly of a heavy-duty vehicle axle/suspension system of claim 7, wherein said axle wrap is positioned at least 1 inch from said beam top wall.

9. The beam for a suspension assembly of a heavy-duty vehicle axle/suspension system of claim 7, wherein said recessed area is positioned above a line drawn through a center of said axle and a pivot point of said beam.

10. The beam for a suspension assembly of a heavy-duty vehicle axle/suspension system of claim 7, wherein said recessed area is positioned at least 0.50 inches above a line drawn through a center of said axle and a pivot point of said beam.

11. The beam for a suspension assembly of a heavy-duty vehicle axle/suspension system of claim 7, wherein said recessed area is positioned at least 0.70 inches above a line drawn through a center of said axle and a pivot point of said beam.

12. The beam for a suspension assembly of a heavy-duty vehicle axle/suspension system of claim 1, wherein said suspension assembly includes a lever arm ratio of at least 1.34.

13. The beam for a suspension assembly of a heavy-duty vehicle axe/suspension system of claim 1, wherein a pair of said beams incorporated into respective ones of a pair of said suspension assemblies provides said axle/suspension system with a weight rating of approximately 20,000 lbs/axle.
